(19) United States
(12) Patent Application Publication
(10) Pub. No.: US 2012/0040072 A1
(43) Pub. Date: Feb. 16, 2012

(54) Waxy Corn Starch And Whole Grain Cereals

(75) Inventors: Robert Chatel, Hoffman Estates, IL (US); Yongsoo Chung, Palatine, IL (US)

(73) Assignee: THE QUAKER OATS COMPANY, Chicago, IL (US)

(21) Appl. No.: 13/279,410

(22) Filed: Oct. 24, 2011

Related U.S. Application Data
(62) Division of application No. 11/313,483, filed on Dec. 21, 2005.

(51) Int. Cl. A23L 1/18; A23P 1/14; A23P 1/12

(52) U.S. Cl. 426/559

(57) ABSTRACT

An improved cereal flour mixture, production method, and resulting cereal are provided. The cereal contains whole grain and can be extruded.

### FIELD OF THE INVENTION

The present invention relates to cereal food compositions and methods of making the same. More specifically, the present invention relates to whole grain cereal foods and methods of making the same.

### BACKGROUND OF THE INVENTION

Breakfast cereal is a common breakfast meal. Typically, such a meal includes a bowl of cereal or a cereal food in some form. In recent years, there has been a growing awareness of the nutritional content of food products. There is a growing demand for whole grain cereals which can provide more nutrients than traditional cereals.

Unfortunately, extruded whole grain cereals cannot be made readily and commercially by simply substituting refined cereal grain flours with whole grain cereal flours. This is because of the different properties of the two types of flours. For example, it has been found that replacing degerminated corn flours, i.e. refined corn flours, with whole corn flours makes direct expanded extrusion cereal products difficult to expand without overcooking, which results in poor flavor and an undesirable soft texture.

Thus, a need exists for a whole grain cereal composition that can be used for direct expanded extrusion products and a method for making the same.

### SUMMARY OF THE INVENTION

According to one aspect of the present invention, a cereal composition is provided. The cereal composition comprises whole grain cereal flour, refined grain cereal flour, sugar, and waxy starch.

The whole grain cereal flour can be any suitable flour known to those skilled in the art. Non-limiting examples of whole grain cereal flours include whole wheat, whole rice, whole corn (maize), whole millets, whole sorghum (milo), whole rye, whole triticale, whole oats, whole barley, whole teff, whole wild rice, whole spelt, whole buckwheat, whole amaranth, whole quinoa, whole kañiwa, whole cockscomb, other whole grain cereal flours known in the art, and combinations thereof. Typically, the whole grain cereal flour is present in an amount from about 25% to about 60%, preferably from about 45% to about 55% by weight of the total dry cereal composition.

The refined grain cereal flour can be any suitable flour known to those skilled in the art. Typically, the refined grain cereal flour is a flour made from debranned and/or degerminated cereal grains. Non-limiting examples of cereal grains that can be debranned and/or degerminated to produce refined grain cereal flour include wheat, rice, corn (maize), millets, sorghum (milo), rye, triticale, oats, barley, teff, wild rice, spelt, buckwheat, amaranth, quinoa, kañiwa, cockscomb, other cereal grains known in the art, and combinations thereof. Typically, the refined grain cereal flour is present in an amount from about 20% to about 40%, preferably from about 25% to about 35% by weight of the total dry cereal composition;

The waxy starch can be any suitable starch known to those skilled in the art. Non-limiting examples of cereal grain sources for waxy starches include rice, corn (maize), sorghum (milo), barley, as well as other varieties of grain or starchy seeds which contain 10% or less of their starch content as amylose, and combinations thereof. Typically, the waxy starch is present in an amount from about 2% to about 10%, preferably from about 3% to about 5% by weight of the total dry cereal composition.

The sugar can be any suitable sugar known to those skilled in the art. Non-limiting examples of sugars include sucrose, fructose, dextrose, other sugars known in the art, and combinations thereof. Typically, the sugar is present in an amount less than about 15% by weight of the total dry cereal composition.

In one embodiment, the cereal composition can further comprise additional varieties of flour such as debranned oat flour and other flour varieties known to those skilled in the art.

According to another aspect of the present invention, a method of producing an extruded whole cereal is provided. The method comprises combining whole grain cereal flour, refined grain cereal flour, and waxy starch to form a cereal flour mixture. Thereafter, the method further includes cooking the cereal flour mixture to form a cereal dough and extruding the cereal dough to form a puffed cereal.

In one embodiment of the present invention, the formation of and cooking of the cereal dough can be done during extruding in a suitable extruder. Typically, such extruding is done at low moisture with high shear. As the cereal exits the extruder, the cereal pieces expand rapidly to produce expanded cereal sometimes also referred to as puffed cereals.

According to yet another aspect of the present invention, a cereal dough composition containing whole grains is provided. The total moisture content of the cereal dough in the extruder is typically in the range between about 16% and about 22% by total weight of the cereal dough. The composition comprises uncooked whole grain cereal flour, uncooked refined grain cereal flour, sugar, uncooked waxy starch, and water.

The source of the cereal flours for each of the corresponding ingredients is the uncooked form of the cereal flours previously described. Typically, the uncooked whole grain cereal-flour is present in an amount-from about 22% to about 57%, preferably from about 40% to about 52% by weight of the total weight of the cereal dough. The amount of uncooked refined grain cereal flour present in the dough composition is typically from about 18% to about 38%, preferably from about 22% to about 33% by weight of the total weight of the cereal dough. The amount of uncooked waxy starch present in the dough composition is typically from about 2% to about 10%, preferably from about 3% to about 5% by weight of the total weight of the cereal dough. Typically, sugar is present in an amount less than about 15% by weight of the total weight of the cereal dough. The amount of water present in the composition is typically sufficient to form a cereal dough and is generally known in the art.

### DETAILED DESCRIPTION OF THE INVENTION

According to one aspect of the present invention, a cereal composition is provided. The cereal composition comprises whole grain cereal flour, refined grain cereal flour, sugar, and waxy starch.

A common problem often encountered during the manufacture of whole grain cereal is inferior product quality as the high temperatures required to achieve the desired degree of expansion overcook the cereal. It has been found that adding relatively small quantities of waxy starch such as waxy corn starch significantly improves the expandability of the cereal pieces. In addition, the extruder can be operated at typical temperatures, making commercially acceptable whole grain cereal products. Typical operating temperatures are generally in the range of from about 320° F. to about 350° F. The whole grain cereal flour can be any suitable flour known to those skilled in the art. Non-limiting examples of whole grain cereal flours include whole wheat, whole rice, whole corn (maize), whole millets, whole sorghum (milo), whole rye, whole triticale, whole oats, whole barley, whole teff, whole wild rice, whole spelt, whole buckwheat, whole amaranth, whole quinoa, whole kañiwa, whole cockscomb, other whole grain cereal flours known in the art, and combinations thereof. Typically, the whole grain cereal flour is present in an amount from about 25% to about 60%, preferably from about 45% to about 55% by weight of the total dry cereal composition.

The term “weight of the total dry cereal” as used herein in conjunction with the terms “composition” or “mixture” means the combined weight of all the dry ingredients exclusive of water and prior to entering the extruder. Those skilled in the art will appreciate that a cereal dough forms only after the addition of water to the dry ingredients and the application of heat in the extruder to the wet ingredients. Furthermore, it will be apparent to those skilled in the art that the resulting cereal pieces exiting the extruder may further comprise a coating such as sugar coating or other coatings known in the art.

The refined grain cereal flour can be any suitable flour known to those skilled in the art. Typically, the refined grain cereal flour is a flour made from debranned and/or degerminated cereal grains. Non-limiting examples of cereal grains that can be debranned and/or degerminated to produce refined grain cereal flour include wheat, rice, corn (maize), millets, sorghum (milo), rye, triticale, oats, barley, teff, wild rice, spelt, buckwheat, amaranth, quinoa, kañiwa, cockscomb, other cereal grains known in the art, and combinations thereof. Typically, the refined grain cereal flour is present in an amount from about 20% to about 40%, preferably from about 25% to about 35% by weight of the total dry cereal composition.

The term “waxy starch” as used herein refers to starch made from cereal grains, i.e. waxy grains, wherein about 10% or less of the starch present within the grains is in the form of amylose. As will be understood by persons skilled in the art, cereal grains such as wheat, barley, oats, corn (maize), and rice are comprised of several components, namely the bran, the germ, and the endosperm. The bran layer includes fiber and protein with some vitamins and minerals. The endosperm is comprised of carbohydrate, in the form of starch, and protein; and the germ includes fat, protein, and sugar as well as some vitamins and minerals. In the case of waxy grains, most of the starch present within the endosperm is in the form of amylopectin, rather than a mixture of amylopectin and amylose present in non-waxy cereal grain. Non-limiting examples of cereal grain sources for waxy starches include rice, corn (maize), sorghum (milo), barley, as well as other varieties of grain or starchy seeds which contain 10% or less of their starch content as amylose, and combinations thereof. Typically, the amount of waxy starch is present in an amount from about 2% to about 10%, preferably from about 3% to about 5% by weight of the total dry cereal composition.

Waxy corn starch is an especially preferred waxy starch in accordance with the invention.

The sugar can be any suitable sugar known to those skilled in the art. Non-limiting examples of sugars include sucrose, fructose, dextrose, other sugars known in the art, and combinations thereof. Typically, the sugar is present in an amount less than about 15% by weight of the total dry cereal composition.

In one embodiment, the cereal composition can further comprise additional varieties of flour such as debranned oat flour and other flour varieties known to those skilled in the art. In addition, it will be apparent to those skilled in the art that the cereal composition of the present invention can further comprise additional ingredients such as natural and artificial flavors, coloring agents, and other ingredients suitable for human consumption or ingredients otherwise known to those skilled in the art.

According to another aspect of the present invention, a method of producing an extruded whole cereal is provided. The method comprises combining whole grain cereal flour, refined grain cereal flour, and waxy starch to form a cereal flour mixture. Thereafter, the method further includes forming and cooking the cereal dough from the flour mixture and extruding the cereal dough to form a puffed cereal.

In one embodiment of the present invention, the cooking of the cereal dough can be done during the extruding in a suitable extruder, as is generally well known in the art for generally making puffed cereals. Typically, such extruding is done at low moisture and high shear. The total moisture content of the cereal dough in the extruder is typically in the range between about 16% and about 22% by total weight of the cereal dough. As the cereal exits the extruder, the cereal pieces expand rapidly to produce an expanded cereal sometimes also referred to as puffed cereals with the cereal length being cut or otherwise divided into pieces as is well known in the art.

The term “total weight of the cereal dough” as used herein means the combined weight of all the dry ingredients and the added water used to form the dough.

According to yet another aspect of the present invention, a cereal dough composition containing whole grains is provided. The composition comprises uncooked whole grain cereal flour, uncooked refined grain cereal flour, sugar, uncooked waxy starch, and water.

The source of the cereal flours for each of the corresponding ingredients is the uncooked form of the cereal flours previously described. Typically, the uncooked whole grain cereal flour is present in an amount from about 22% to about 57%, preferably from about 40% to about 52% by weight of the total weight of the cereal dough. The amount of uncooked refined grain cereal flour present in the dough composition is typically from about 18% to about 38%, preferably from about 22% to about 33% by weight of the total weight of the cereal dough. The amount of uncooked waxy starch present in the dough composition is typically from about 2% to about 10%, preferably from about 3% to about 5% by weight of the total weight of the cereal dough. Typically, sugar is present in an amount less than about 15% by weight of the total weight of the cereal dough. The amount of water present in the composition is typically sufficient to form a cereal dough and is generally known in the art.

Those skilled in the art will appreciate that the compositions disclosed above can further comprise minor ingredients such as vitamins, minerals, dough conditioners, and other ingredients known to those skilled in the art.

### EXAMPLES

### Example 1

### Whole Corn and Oat Cereal

A whole corn and oat cereal can be prepared using the following ingredients:

| Ingredients | Parts By Weight |
|---|---|
| Whole Yellow Corn Flour | 36.0 |
| Degerminated White Corn Flour | 30.0 |
| Whole Oat Flour | 12.0 |
| Rice Flour | 8.0 |
| Sugar | 8.0 |
| Waxy Corn Starch | 4.0 |
| Salt | 1.8 |
| Minor Ingredients | 0.2 |
| Total | 100.0 |

The whole corn and oat cereal can be prepared by mixing the ingredients to form a cereal flour mixture. Water is added to the flour composition to form a cereal dough, which is subsequently cooked and extruded in a cereal extruder to form expanded (puffed) cereal pieces. To achieve the desired degree of expansion, the cereal extruder is operated to attain a dough temperature between about 320° F. and about 350° F. The total moisture content of the cereal dough in the extruder is between about 16 and 22% by weight of the total the cereal dough.

### Example 2

### Whole Corn, Refined Corn and Debranned Oat Cereal

A whole corn, refined corn and debranned oat cereal can be prepared using the following ingredients:

| Ingredients | Parts By Weight |
|---|---|
| Whole Yellow Corn Flour | 50.0 |
| Degerminated White Corn Flour | 20.0 |
| Partially Debranned Oat Flour | 18.0 |
| Sugar | 6.0 |
| Waxy Corn Starch | 4.0 |
| Salt | 1.8 |
| Minor Ingredients | 0.2 |
| Total | 100.0 |

The corn and oat cereal can be prepared using the process set forth in Example 1 above.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

We claim:

1. A method of producing a puffed whole cereal comprising: combining whole grain cereal flour, refined grain cereal flour, and waxy starch to form a cereal flour mixture; adding water to the cereal flour mixture, cooking the cereal mixture to form a cereal dough; extruding the cereal dough, and expanding the extruded cereal dough to form the puffed whole cereal.

2. The method according to claim 1 wherein the cooking of the cereal flour mixture occurs during the extruding.

3. The method according to claim 2 wherein the water is added during the extruding.

4. The method according to claim 1 wherein the extruding occurs under low moisture and high shear.

5. The method according to claim 4 wherein the water is added in an amount to provide a total moisture content of the cereal dough in the extruder in a range between 16% and 22% by total weight of the cereal dough.

6. The method according to claim 1 wherein the cereal flour mixture comprises, on a dry weight basis, from 25% to 60% whole grain cereal flour by weight of the total cereal flour mixture;
comprises from 20% to 40% refined grain cereal flour by weight of the total dry cereal mixture;
less than 15% by weight sugar of the total dry cereal mixture; and from 2% to 10% waxy starch by weight of the total dry cereal mixture.

7. The method according to claim 1 wherein the whole grain cereal flour is selected from the group consisting of whole wheat, whole rice, whole corn, whole millets, whole sorghum, whole rye, whole triticale, whole oats, whole barley, whole teff, whole wild rice, whole spelt, whole buckwheat, whole amaranth, whole quinoa, whole kaniwa, whole cockscomb, and combinations thereof.

8. The method according to claim 1 wherein the refined grain cereal flour is selected from the group consisting of wheat, rice, corn, millets, sorghum, rye, triticale, oats, barley, teff, wild rice, spelt, buckwheat, amaranth, quinoa, kaniwa, cockscomb and combinations thereof.

9. The method according to claim 1 wherein the waxy starch is selected from the group consisting of rice, corn, sorghum, barley starches and combinations thereof.

10. The method according to claim 1 wherein the extruding operates at a temperature in the range from 320° F. to 350° F.

11. A puffed whole cereal prepared by combining whole grain cereal flour, refined grain cereal flour, and waxy starch to form a cereal flour mixture; adding water to the cereal flour mixture, cooking the cereal mixture to form a cereal dough; extruding the cereal dough, and expanding the extruded cereal dough to form the puffed whole cereal.

12. The puffed whole cereal according to claim 11 wherein the cereal flour mixture comprises, on a dry weight basis, from 25% to 60% whole grain cereal flour by weight of the total cereal flour mixture; comprises from 20% to 40% refined grain cereal flour by weight of the total dry cereal mixture; less than 15% by weight sugar of the total dry cereal mixture; and from 2% to 10% waxy starch by weight of the total dry cereal mixture.

13. The puffed whole cereal according to claim 11 wherein the whole grain cereal flour is selected from the group consisting of whole wheat, whole rice, whole corn, whole millets, whole sorghum, whole rye, whole triticale, whole oats, whole barley, whole teff, whole wild rice, whole spelt, whole buckwheat, whole amaranth, whole quinoa, whole kaniwa, whole cockscomb, and combinations thereof.

14. The puffed whole cereal according to claim 11 wherein the refined grain cereal flour is selected from the group consisting of wheat, rice, corn, millets, sorghum, rye, triticale, oats, barley, teff, wild rice, spelt, buckwheat, amaranth, quinoa, kaniwa, cockscomb and combinations thereof.

15. The puffed whole cereal according to claim 11 wherein the waxy starch is selected from the group consisting of rice, corn, sorghum, barley starches and combinations thereof.
